(19) United States
(12) Patent Application Publication
(10) Pub. No.: US 2019/0362003 A1
(43) Pub. Date: Nov. 28, 2019

(54) TECHNIQUES FOR PROCESSING LONG-TAIL SEARCH QUERIES AGAINST A VERTICAL SEARCH CORPUS

(71) Applicant: Microsoft Technology Licensing, LLC, Redmond, WA (US)

(72) Inventors: Yongzheng Zhang, San Jose, CA (US); Rui Zhao, Mountain View, CA (US); Zhou Jin, Fremont, CA (US); Chi-Yi Kuan, Fremont, CA (US)

(21) Appl. No.: 15/988,894

(22) Filed: May 24, 2018

(51) Int. Cl. G06F 17/30

(52) U.S. Cl. CPC G06F 17/30392; G06F 17/30477

(57) ABSTRACT

Techniques in a search system for improving the precision and recall of search results returned for search queries including long tail queries submitted against a vertical search corpus are disclosed. The techniques include mapping a user query submitted to the system to a more representative query and executing the more representative query against the vertical search corpus. Documents identified as matching the more representative query may be returned in a search result as an answer to the user query in addition to or instead of documents identified as matching the user query. By including the documents identified as matching the more representative query in the search result, the search result may be relevant to the user than a search result that includes just documents matching the user query.

### TECHNICAL FIELD

The present disclosure relates to computer search systems. In particular, the present disclosure relates to computer-implemented techniques for improving the precision and recall of search results returned for long tail search queries submitted against a vertical search corpus.

### BACKGROUND

Computers are very powerful tools for performing a wide-variety of information processing tasks. One information processing task computers are very useful for is searching for relevant information among a corpus of information. Inverted indexes are common mechanism for efficiently identifying information of interest among a corpus using a computer. A typical inverted index is a mapping of keywords to the documents in the corpus that contain or are associated with the keywords. As one example, an inverted index of the world's publicly accessible web pages may map words in the web pages to the subset of the web pages that contain that word.

Between the actual physical inverted index itself (e.g., the index data as stored on one or more computers) and the users of the system, a search system is typically provided as a software cushion or layer. In essence, the search system shields the user from knowing or even caring about underlying search system details. Typically, all requests from users for information in the inverted index are processed by the search system. For example, documents relevant to a user's request for information may be identified by the search system using the inverted index, all without user knowledge of the underlying search system implementation. In this manner, the search system provides users access to relevant information without concern to how the information is indexed or accessed. One well-known search system for identifying relevant information among the world's publicly accessible web pages is the GOOGLE search system provided by Google Inc. of Mountain View, Calif.

One function of a search system is answer to search queries (or just “queries” for short). A query may be defined as a logical expression including a set of one or more search keywords, and results in the identification of a subset of indexed documents. Consider, for instance, the handling of a request for information from a large-scale search engine. In operation, this request is typically issued by a client system as one or more Hyper Text Transfer Protocol or “HTTP” requests for retrieving particular search results (e.g., a list of Internet web pages containing the words “college” and “basketball”) from indexes on server computers. In response to this request, the search system typically returns a web page containing hyperlinks to those Internet web pages considered to be most relevant to the search terms “college” and “basketball”.

Large-scale search systems are well-suited for searching a very large search corpus such as all the world's information that is publicly available on the Internet (e.g., trillions of web pages). However, search systems are also used to search relatively smaller “vertical” search corpuses. A vertical search corpus may contain a relatively small number of documents (e.g., tens of thousands of documents or fewer) pertaining to a particular information domain. For example, a vertical search corpus might be a set of authored online help documents (e.g., technical knowledge base) that users of an online service can search to discover documents that instruct the user how to solve a particular issue the user is having with the online service. For example, if a user wishes to deactivate a user account that the user holds with the online service, then the user might submit the query “deactivate account” to the search system. The search results provided by the search system to the user may include a link to a document instructing the user how to deactivate their account. Online services often provide such search capabilities to their users to make the online service more user-friendly and to reduce monetary costs associated with providing dedicated technical support personnel to users.

A challenge of search systems, both large-scale search systems and vertical search systems, is how to effectively process so-called “long tail” queries. Of the distinct search queries that a search system receives, there are typically a smaller number of them (e.g., 20% of all distinct queries) that are each submitted many times by users and a larger number of them (e.g., 80% of all distinct queries) that are submitted substantially fewer times each. A long tail query is so named because it is one of the larger number of distinct queries in long tail end of a graph where the x-axis represents the set of distinct queries submitted in decreasing order of the number of submissions and the y-axis represents the number of submissions. Typically, such a graph drops off steeply, then heads rightward with a relatively flat long tail. The tail represents the distinct queries that individually are unpopular but that collectively represent a significant portion (e.g., 50%) of query submissions to the search system. Thus, developers, operators, and users of search systems would appreciate ways to the improve the precision and recall of search results returned for long tail search queries submitted to the search system.

Such solutions would be especially appreciated for developers, operators, and users of vertical search systems. One possible solution to improve the precision and recall of search results returned by a search system for a long tail query is to use a neural network (e.g., a recurrent neural network) or other deep learning neural network. For example, a deep learning neural network might be trained to suggest an alternative query for a given long tail query. However, implementing a deep learning neural network to do this for a vertical search system may be impractical because of the complexity involved in such an implementation and/or because of the lack of sufficient training data. Other issues with a deep learning neural network may include the lack of interpretable learning features such that it is difficult for the human developers and operators to reason about why the neural network suggested a particular alternative query for a particular input query.

Thus, what is needed is a relatively simple (compared to using a deep learning neural network to predict a user's information need from a long tail query), yet effective solution for the improving the precision and recall of search results returned for long tail search queries submitted to a vertical search system. The present disclosure provides a solution to this and other needs. The solution may be used instead of or in conjunction with other solutions for improving the precision and recall of search results returned for long tail search queries submitted to a vertical search system.

The approaches described in this section are approaches that could be pursued, but not necessarily approaches that have been previously conceived or pursued. Therefore, unless otherwise indicated, it should not be assumed that any of the approaches described in this section qualify as prior art merely by their inclusion in this section.

### BRIEF DESCRIPTION OF THE DRAWINGS

In the drawings:

FIG. 1 is a process for processing a user query against a vertical search corpus.

FIG. 2 is a process for determining entries to add to a query mapping dictionary based on textual similarity between historical user queries.

FIG. 3 is a process for determining entries to add to a query mapping dictionary based on semantic similarity between historical user queries.

FIG. 4 is schematic diagram of a search system.

FIG. 5 is a schematic diagram of a computing system comprising one or more processors and storage media that may be used in an implementation of the techniques disclosed herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques in a search system for improving the precision and recall of search results returned for search queries including long tail queries submitted against a vertical search corpus are disclosed. The techniques include mapping a user query submitted to the system to a more representative query and executing the more representative query against the vertical search corpus. Documents identified as matching the more representative query may be returned in a search result as an answer to the user query in addition to or instead of documents identified as matching the user query. By including the documents identified as matching the more representative query in the search result, the search result may be relevant to the user than a search result that includes just documents matching the user query.

Consider, for example, a vertical search corpus containing a document with end user instructions for closing an account held with an online service. The document may contain the keywords “close” and “account” and the document may be indexed by the search system in an inverted index by those keywords. A user of the search system, unware how the document is indexed or the keywords it contains, may submit a query other than “close account” or “how do I close my account” such as “terminate account” or “how do I terminate my account.” Unfortunately, the document may not contain the keyword “terminate” and therefore may not be indexed by that keyword. In this case, according to techniques disclosed herein, the search system may map the user query “terminate account” to a more representative query such as “close account.” This query is more representative because it contains keywords by which the document satisfying the user's information need is indexed. As such, the search result returned for the more representative query includes the document satisfying the user's information need whereas a search result returned for just the original user query may not have returned that document.

According to techniques disclosed herein, the search system maps a user query to a more representative query using a query mapping dictionary. The query mapping dictionary may contain at least two different types of entries. Both types of entries map a string representing a query to another string representing a query. For example, an entry may map the string “terminate account” to the string “close account.” The two types of entries differ by the manner in which the mapping they represent is determined. One type of entry is based on the textual similarity between the user query and the more representative query to which it is mapped by the entry. Another type of entry is based on the semantic similarity between the user query and the more representative query to which it is mapped by the entry. Both types of entries may be included in the query mapping dictionary. Both types of entries are created based on historical users queries that were previously submitted to the search system. Techniques for determining the entries to include in the query mapping dictionary based on historical user queries are described in greater detail herein.

A search system that implements techniques disclosed herein may realize one or more benefits thereby resulting an improved search system.

A benefit of some techniques disclosed herein is that the precision and recall (i.e., the relevance) of search results returned for user queries submitted to the search system is improved. Returning to the example above, by mapping the query “terminate account” to the more representative query “close account,” precision of the search result is improved because documents containing or associated with the keywords “terminate” and “account” that do not satisfy the user's information needed are not returned in the search results, or at least not indicated in the search results as more relevant to the representative query than the document satisfying the user's information need. Recall of the search results is improved because the document pertaining to closing an account and that satisfies the user's information need is returned in the search results whereas the document may not have been returned if only documents matching the user query were returned in the search result.

Another benefit of some techniques disclosed herein is the ease of implementation. In particular, training a deep learning neural network, including collecting sufficient amount of training data examples in order to train the neural network adequately, is not required. This is important for some vertical search systems where the query volume and corpus size is such that collecting a sufficient number of training examples is not practical.

The techniques will now be described with reference to the figures.

### Query Mapping Process

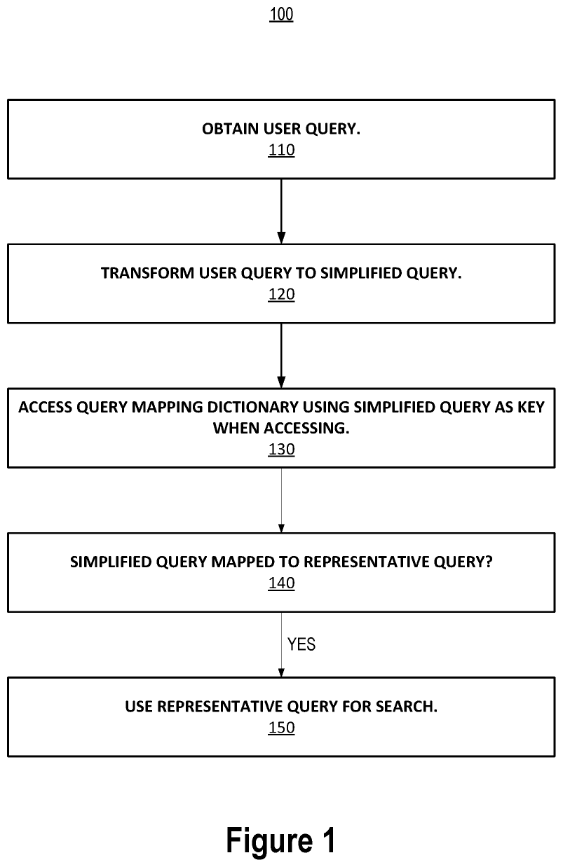

FIG. 1 is a process 100 for processing a user query in a search system including mapping the user query to a more representative query. The process 100 includes the operations of obtaining a current user query 110, transforming the current user query to a simplified query 120, accessing a query mapping dictionary using the simplified query as a key when accessing the dictionary to map the simplified query to a representative query 130, and using the representative query to answer a user's information need 150 under the condition that the simplified query was able to be mapped to the representative query using the query mapping dictionary 140.

It should be noted that the condition of operation 140 that the simplified query was able to be mapped to the representative query may not be sufficient to perform operation 150 in some implementations or in some instances. For example, one or more other conditions in addition to the condition of operation 140 may each may be required to be satisfied as a condition on performing operation 150. However, in other implementations or circumstances, the condition of operation 140 may be both a necessary and sufficient condition on performing operation 150. Process 100 is also not exclusive of another process in which the user query is mapped to the representative query yet the condition of operation 140 is not satisfied (e.g., because the other process maps the user query to the representative query using a different query mapping dictionary or another query mapping process.) In that case, the other process may use the representative query to answer the user query even though the condition of operation 140 is not satisfied.

It should also be noted that even if the condition of operation 140 is satisfied, the user query or the simplified query may also be used to answer the user's information need in addition to using the representative query to answer the user's information need in operation 150. For example, documents identified as matching the user query or the simplified query may be merged with documents identified as matching the representative query (e.g., according to respective relevance scores) and the merged set of documents may be returned (identified) in a search result as an answer to the user query.

### Obtaining the User Query

Returning again to the top of process 100, at operation 110, a user query is obtained by the search system. The user query may be a character string composed of one or more keywords separated by whitespace. For example, in the string “how do I terminate my account” each of the following sub-strings are keywords: “how”, “do” “I”, “terminate”, “my”, and “account.”

The search system can obtain the user query using a variety of different technologies and protocols. For example, the search system can obtain the user query from a computing device over a data network using one or more following networking technologies: TCP, IP, HTTP, HTTPS, etc.

A user of the computing device may submit the user query to the search system by inputting (entering) the user query to the computing device using one or more user input devices of the computing device. For example, the user may use a keyboard device or touch screen device to enter the characters of the user query into a text input box presented on a web page or other user interface in a web browser or other user application at the computing device. The application may then send the user query over the data network whereby the user query is obtained by the search system.

Other ways of obtaining 110 the user query that will be apparent to one skilled in the art from this description are possible and the techniques herein are not limited to any particular way of obtaining the user query. For example, the user query may have been previously submitted to the search system. In this case, the user query may be obtained from a query log, or the like, for the purpose of resubmitting the user query against the search system. For example, the user query may be resubmitted to the search system to test an implementation of the techniques disclosed herein.

### Simplifying the User Query

At operation 120, the search system transforms the user query to a simplified query. This transformation may include a lemmatization process and a parts-of-speech (POS) tagging and pattern matching process. The simplification of the user query to the simplified query is useful for handling never-before-submitted (or not recently submitted) long tail user queries. For example, both of the user queries “how do I void my account” and “void my account” having the same information need may be simplified by the transformation operation 120 to the simplified query “void account” which then may be mapped using the query mapping dictionary at operation 130 to the representative query “close account.” To do this, only a single-entry mapping “void account” to “close account” in the query mapping dictionary is needed and an entry for each of the user queries is not needed. Thus, as well as being useful to handle different long tail queries for the same information need including never-before or not-recently submitted long-tail queries for that information need, the transformation operation 120 also reduces the data storage requirements of the query mapping dictionary.

The transformation operation 120 including the lemmatization process and the POS tagging and matching process will now be discussed in greater detail.

### Lemmatization

The lemmatization process reduces different inflectional forms of a keyword to the keyword's base or dictionary form (i.e., the keyword's lemma). The lemmatization process may perform a dictionary-based and/or rule-based morphological analysis on the keyword to identify its lemma. The lemmatization process may be applied to the user query or other input query string to simplifying the input query string. For example, the lemmatization process may transform the input query string “removing account” to the produce the output query string “remove account” where “remove” is the lemma of the inflected form “removing.” The lemmatization process may also be performed and applied by the search system during indexing to documents of the vertical search corpus such that the documents are indexed in the inverted index by the lemmas of keywords contained in or associated with the documents.

Other lemmatization processes for simplifying an input query string will be apparent to one skilled in the art and the techniques are not limited to any particular lemmatization process for simplifying the input query string, or even that a lemmatization process be performed to simplify the input query string. For example, the particular lemmatization process performed may vary depending on the language of the input query string (e.g., English, French, German, Turkish, etc.)

### Parts-of-Speech Tagging and Matching

The POS tagging and matching process may be applied to the user query or other input query string (e.g., the output of the lemmatization process as applied to the user query) to identify noun phrases and verb phrases in the input query string. Such identification is then used to simplify the input query string. For example, the input query string “remove my account” may be simplified as “remove account.” As another example, the input query string “how can I delete my account?” may be simplified as “delete account.”

To simplify an input query string, the POS tagging and matching process may include a tagging sub-process, a matching sub-process, and a topic pruning sub-process, as described in greater detail below.

The tagging sub-process may include tagging keywords of an input query string for parts-of-speech (e.g., nouns, verbs, adjectives, adverbs, etc.) For example, a log-linear POS tagger may be used in an implementation of the tagging sub-process. One non-limiting example of a log-linear POS tagger that may be used is described in the paper: Kristina Toutanova and Christopher D. Manning. 2000. Enriching the Knowledge Sources Used in a Maximum Entropy Part-of-Speech Tagger. In Proceedings of the Joint SIGDAT Conference on Empirical Methods in Natural Language Processing and Very Large Corpora (EMNLP/VLC-2000), pp. 63-70.

The output of the tagging sub-process for a given input query string may be a sequence of POS tags for the string. For example, the input query string “I would like to delete my account” might have the POS sequence of “I/PRN would/MD like/VB to/TO delete/VB my/PRP$ account/NN.” In this example, “/PRN,” “/MD,” “/VB,” “/TO,” “PRP$,” and “/NN” are parts-of-speech tags according to the Penn Treebank English POS tag set.

The matching sub-process matches POS tag sequences output by the tagging sub-process to predefined POS patterns. In some implementations, the predefined POS patterns are represented in regular expressions. In some implementations, there are three different predefined POS patterns: an entity POS pattern, an event topic I POS pattern, and an event topic II POS pattern. These three POS patterns are useful for identifying the most important topics (concepts) related to the user's information need in an input query string.

The entity POS pattern includes a recursive noun phrase representing an entity (e.g., “account” or “primary account”). The recursive noun phrase is a noun phrase preceded by zero more other noun phrases or modifiers. Modifiers may include adjectives, numbers, and pronouns. For example, the string “primary account” having a POS sequence of “primary/JJ account/NN” may be matched to the regular expression for the recursive noun phrase to obtain the two noun phrases: “account” and “primary account.”

The event topic I POS pattern includes a noun phrase followed by a verb phrase. This pattern represents an event in the form of a noun phrase followed by a verb phase such as an action associated with an entity, like “primary account closed.”)

An event topic II POS pattern includes a verb phrase followed by a noun phrase. This pattern represents an event in the form of a verb phrase followed by a noun phrase. The verb phrase may be separated from the noun phrase by a list of modifiers like pronouns or numbers, such as, for example, “close my account”.

The matching sub-process may output one or more subsequences of the input query string that each match any of the three POS patterns above. The subsequences are then input to the topic pruning sub-process. The topic pruning sub-process reduces overlap and removes unnecessary words or phrases among the one or more subsequences. To do this, the topic pruning sub-process may perform stemming, may remove stop words, and may merge semantically-related lexical items.

Stemming may include reducing inflected keywords to their stems using a stemming algorithm (e.g., a Porter stemmer implementation). For example, after stemming, all of the following different subsequences “close account,” “close accounts,” and “closed account” may be transformed to “close account.”

Removing stop words may include removing common words from the subsequences such as articles, prepositions, pronouns, conjunctions, or other function words listed in a stop word list. For example, after removing stop words, the different subsequences “close the account” and “close my account” may be transformed to “close account.”

Merging semantically related lexical items may include using a synonym dictionary or lexical database to match synonyms in the subsequences such as, for example, “e-mail address” and “email account” to a common sequence such as, for example, “email address.”

The pruned subsequences output by the topic pruning sub-process may then be output from the POS tagging and matching process as a simplified form of the query string input to the POS tagging and matching process.

If both the lemmatization process and the POS tagging and matching process are performed, then the output of one process may be the input to other process. For example, the lemmatization process may be applied to the query string and the lemmatized query string output by the lemmatization process may be provided as input to the POS tagging and matching process. In this case, the output of the POS tagging and matching process is the simplified query. Alternatively, the reverse may be performed. That is, the POS tagging and matching process may be applied to the current query string and the string output by this process can be provided as input to the lemmatization process. In this case, the output of the lemmatization process is the simplified query. It is also possible to perform only the lemmatization process on the query string and not perform the POS tagging and matching process or perform only the POS tagging and matching process on the query string and not perform the lemmatization process. It is also possible for the lemmatization process to be performed as a sub-process of the POS tagging and matching process, or vice versa.

Other POS tagging and matching processes for simplifying an input query string will be apparent to one skilled in the art and the techniques are not limited to any particular POS tagging and matching process for simplifying the input query string, or even that a POS tagging and matching process be performed to simplifying the input query string. For example, the particular POS tagging and matching process may vary depending on the language of the input query string (e.g., English, French, German, Turkish, etc.)

Other ways of transforming 120 the user query to a simplified form of the user query that will be apparent to one skilled in the art from this description are possible and the techniques herein are not limited to any particular way of transforming 120 the user query to a simplified query.

### Query Mapping

At operation 130, the simplified query resulting from the performance of operation 120 as applied to the user query is used as a key to access the query mapping dictionary. The query mapping dictionary may contain a set of query strings as the keys of the dictionary and a set of query strings as the values of the dictionary. Multiple keys may be mapped to the same value as would be the case where multiple long tail queries are mapped to the same representative query. The query mapping dictionary may be implemented in a computer using a suitable data structure (e.g., a hash map, a N-ary search tree, etc.). In selecting an implementation of the query mapping dictionary, lookups of existing entries may be optimized over adding new entries to the dictionary so as to minimize the latency that the lookups add to processing of user queries by the search system.

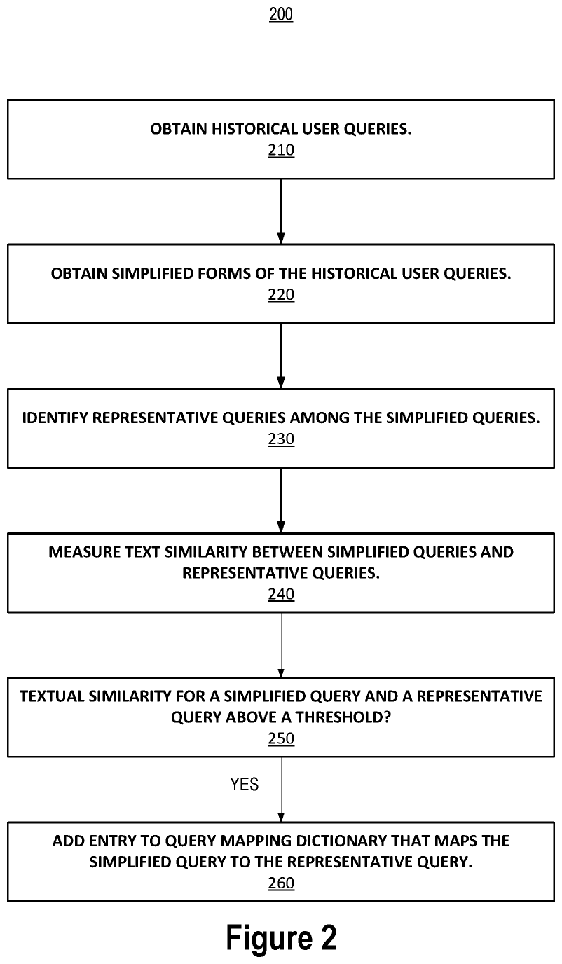

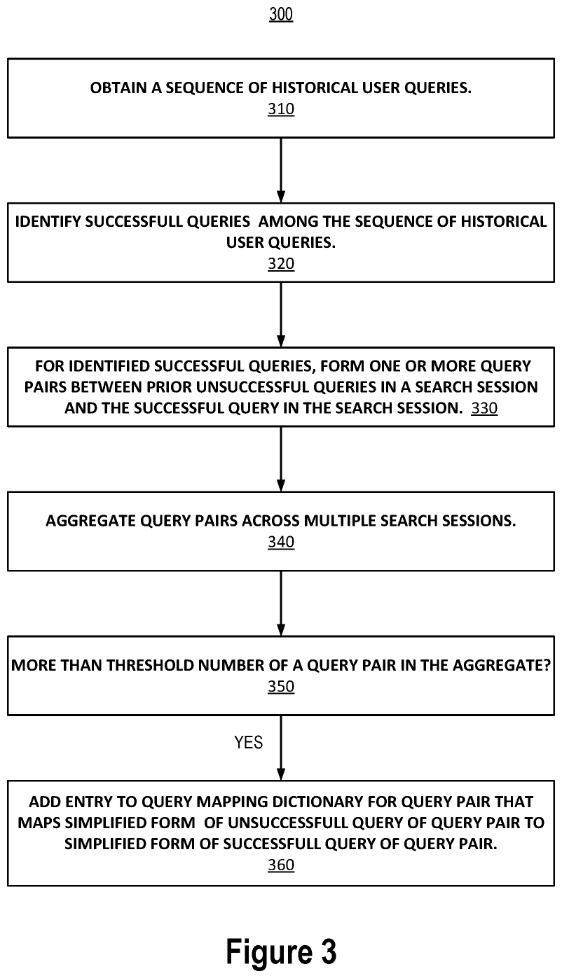

As mentioned, the keys of the query mapping dictionary represent simplified forms of a set of user queries and the values of the query mapping dictionary represent a set of representative queries for the set of user queries. Each entry of the query mapping dictionary may map a simplified query to a representative query. Techniques for determining the entries to include the query mapping dictionary based on textual and semantical similarities between the historical user queries are described in greater detail below with respect to FIG. 2 (textual similarity) and FIG. 3 (semantic similarity).

At operation 140, if the query mapping dictionary contains an entry keyed by the simplified query, then the representative query to which the simplified query is matched by the entry may be used to answer the user's information need. As an example, if the simplified form of the user query is “void account” or “termanate account” (terminate is misspelled by the user), then the representative query might be “close account.”

Using the representative query for the search at operation 150 may include using the keywords of the representative query to load posting lists from the inverted index that indexes the vertical search corpus and then merging the loaded postings to identify documents matching the representative query. The matching documents may be identified in a search result that is returned to the user or querier from which the user query was obtained 110. The matching documents may be ranked within the returned search result according to relevance to the representative query.

As a result of performing process 100, the search system is able to use the query mapping dictionary to map long tail or less popular user queries such as, for example, “deactivating my account” or “how to permanently delete my account” that do not return relevant documents when submitted against a vertical search corpus of documents (e.g., a technical knowledge base of authored articles) to more representative queries such as, for example, “close account” that do return relevant documents.

Techniques for determining the entries to include in the query mapping dictionary will now be described in greater detail with respect to FIG. 2 and FIG. 3.

### Constructing the Query Mapping Dictionary

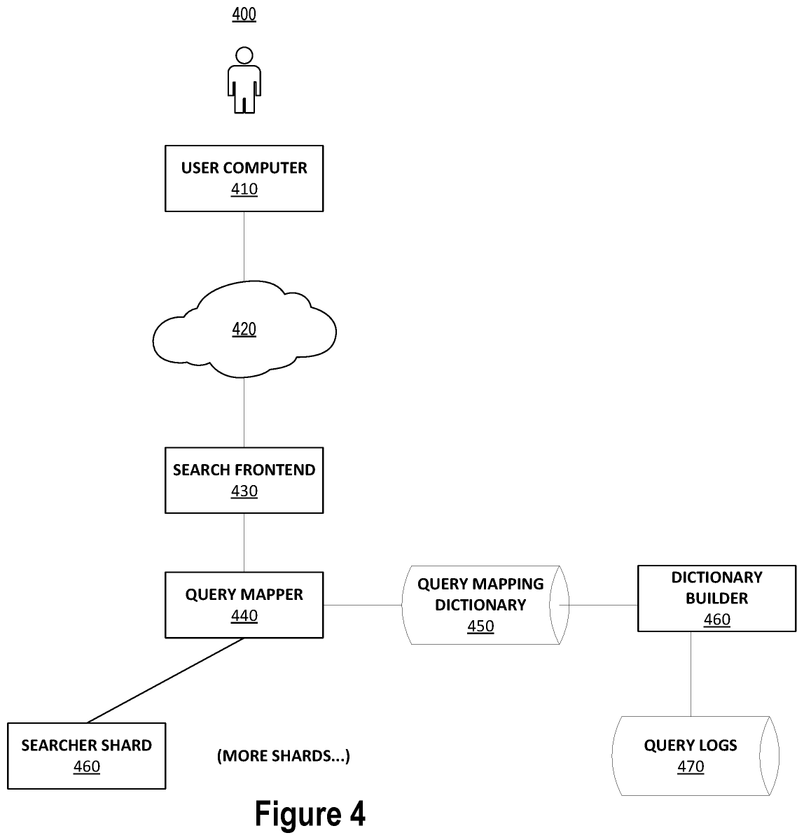

In some implementations, two different techniques are used to determine the entries to include in the query mapping dictionary. One technique is based on textual similarity between historical user queries. The other technique is based on semantic similarity between historical user queries. The textual similarity technique is especially useful for handling keywords misspellings or alternative keyword spellings in user queries submitted to the search system (e.g., as part of process 100 above) and thereby improve the precision and recall of the search system. The semantic similarity technique is especially useful for mapping correctly spelled less popular and long tail user queries submitted to the search system to more representative queries (e.g., as part of process 100 above) and thereby improve the precision and recall of the search system. An implementation of the textual semantic similarity technique is described in greater detail below with respect to FIG. 3. An implementation of the semantic similarity technique is described in greater detail below with respect to FIG. 4.

The query mapping dictionary may include just entries determined according to the textual similarity technique (e.g., process 300 of FIG. 3), just entries determined according to the semantic similarity technique (e.g., process 400 of FIG. 4), or both textual similarity-based and semantic similarity-based entries. In any of these cases, the query mapping dictionary may include entries determined according to other techniques.

### Textual Similarity Approach

FIG. 2 is a process 200 for determining entries to include in the query mapping dictionary according to the textual similarity between historical user queries. The process 200 includes the operations of obtaining historical user queries 210, obtaining simplified forms of the historical user queries 220, identifying representative queries among the simplified queries 230, and measuring the textual similarity between simplified queries and the representative queries 240. An entry is added 260 to the query mapping dictionary mapping a simplified query to a representative query on the condition that the measured textual similarity between the simplified query and the representative query is above a threshold textual similarity 250.

It should be noted that the condition of operation 250 that the measured textual similarity exceed a threshold may not be sufficient to perform operation 250 in some implementations or in some instances. For example, one or more other conditions in addition to the condition of operation 250 may each may be required to be satisfied as a condition on performing operation 260. However, in other implementations or in other circumstances, satisfaction of the condition of operation 250 may be sufficient to perform operation 260. Furthermore, process 200 is also not exclusive of another process in which an entry is added to the query mapping dictionary based on textual similarities between queries even though the condition of operation 250 may not be satisfied.

### Obtaining the Historical User Queries

Returning again to the top of process 200, a set of historical user queries is obtained 210. The set of historical user queries may be obtained from logs or log files maintained by the search system. The search system may maintain such logs for recording information about actual user queries submitted to the search system. Each log entry for a historical user query may contain all of the following information pertaining to the historical user query, or a subset, or a superset thereof:
A unique identifier of the query,
The query string,
An identifier of the user or user account that submitted the query,
The date and time of the query was obtained, processed, and/or answered by the search system,
An identifier of a user session of which the query is one of one or more queries submitted to the search system during the user session,
Identifiers of documents returned in the search result to the query,
The relevance/ranking scores for documents returned in the search result to the query,
Identifiers of documents that received a click-through when presented in the search result to the user, and
For documents that received a click-through, the dwell time the user spent viewing the document, or a qualitative assessment thereof (e.g., “long click” or “short click”).

While the above-information may be stored in a single log, the above-information may be aggregated from multiple logs (e.g., using a map-reduce process or other log aggregation process.) For example, a search system may maintain a “query” log, a “search result” log, and a “click-through” log and the above-information may be aggregated for user queries from these logs. A log entry in the query log for a user query may include, for example, a unique identifier of the query, the query string, an identifier of the user or user account that submitted the query, the date and time of the query was obtained, processed, and/or answered by the search system, and an identifier of a user session of which the query is one of one or more queries submitted to the search system during the user session, among other possible query log information. A log entry in the search result log for a user query may include, for example, a unique identifier of the query, identifiers of documents returned in the search result to the query, and the relevance/ranking scores for documents returned in the search result to the query, among other search result log information. A log entry in the click-through log for a user query may include, for example, a unique identifier of the query, identifiers of documents that received a click-through when presented to the user in the search result for the query, and the dwell time the user spent viewing the document, or a qualitative assessment thereof (e.g., “long click” or “short click”), among other possible click-through information.

The set of historical user queries that are obtained may be filtered from one or more logs such one or more the example logs discussed above. Various filtering criteria may be used to the filter historical user queries from a log or logs. For example, one possible filtering criterion may be time (e.g., historical user queries submitted in the past month, past 90 days, past year, etc.). Another possible filtering criterion may be the vertical search corpus against which historical user queries were submitted against. For example, the search system may separately index two or more vertical search corpuses. In this case, the set of historical user queries obtained 210 according to the filtering criteria may be those submitted against a particular search corpus. The set of obtained 210 historical user queries may then be used for the purpose of adding entries to the query mapping dictionary used to process 100 user queries against that particular search corpus. Various filtering criterion may also be combined. For example, the prior example filtering criteria may be combined to obtain all historical user queries submitted against a particular vertical search corpus in the past ninety days, or the like.

At operation 220, simplified forms of the obtained 210 historical user queries are obtained. These simplified queries may be generated according to the same algorithm used to transform the user query to a simplified query as in operation 120 of process 100 discussed above. For example, each historical user query obtained 210 may be transformed to a corresponding simplified query according to that algorithm to obtain 220 a set of simplified queries corresponding to the set of historical queries obtained 210. Note that this transformation need not be performed at the time the simplified queries are obtained 220. Nor is it required that this transformation be performed after the historical user queries are obtained 210. For example, the historical user queries obtained at operation 210 may have been transformed to the simplified queries obtained at operation 220 prior to the performance of operation 210. For example, the simplified queries may be stored in the log or logs from which the historical user queries are obtained 210 or in a separate log or logs where the transformation of the historical user queries to the simplified queries is performed prior to performance of operation 210. Nonetheless, it is also possible for an implementation to transform the obtained 210 historical user queries to the obtained simplified queries 220 during or after performance of operation 210. As such, performance of operations 210 and 220 may overlap or may be performed one after the other.

### Identifying Representative Queries

At operation 230, a set of representative queries are identified from among the set of simplified queries obtained 220. The simplified queries included in the set of representative queries are those for which the corresponding historical user queries were “effective” according to one or more search result relevance metrics. In a general sense, an “effective” historical user query is one where one or more search result relevance metrics about the search result returned by the search system for the historical user query indicates that user's information need was satisfied by the search results. A variety of different search result relevance metrics may be used to measure the effectiveness of an historical user query including all of the following search result relevance metrics, or a subset, or a superset thereof:
The number of submissions of the historical user query during a period of time (e.g., the past month, the past 90-days, etc.),
The click-through rate for the historical user query (e.g., the percentage of search results returned for submissions of the historical user query where the user clicked on at least one search result), and
The hit rate for the historical user query (e.g., the percentage of search results returned for submission of the historical user query where at least one matching document is identified).

In some implementations, an effectiveness score is computed for each historical user query obtained 210. The effectiveness score for the historical user query may represent a mathematical combination of one or more search result relevance metrics for the historical user query. It is also possible to weight each of the metrics in the combination. The representative queries may be identified 230 from among the simplified queries based on the effectiveness scores computed for the corresponding historical user queries. For example, the top-N number or the top-M percent of simplified queries may be identified as the set of representative queries based on the top-N effectiveness scoring corresponding historical user queries or the top-M percent effectiveness scoring corresponding historical user queries. Alternatively, all simplified queries with corresponding historical user queries having an effectiveness score above an effectiveness score threshold may be identified as the set of representative queries. The number N, the percent M, and the effectiveness score threshold may be selected according to a variety of different factors. For example, the number N, the percent M, or the effectiveness score threshold may reflect a number of historical user queries or a percentage of historical user queries (e.g., determined empirically) that fall in the head of a distribution of historical user queries having a long-tail.

### Measuring Textual Similarity

At operation 240, textual similarities between the simplified queries obtained 220 and the representative queries identified 230 are measured. A textual similarity score (numerical value) may be computed for each distinct unordered pair of the obtained 220 simplified queries and the identified 230 representative queries. A higher textual similarity score may indicate greater textual similarity between the simplified query and the representative query than a lower score. However, it is also possible for a lower textual similarity score to indicate greater textual similarity between the queries than a higher score depending on the particular textual similarity measure or measures used. In some implementations, pairs of the same query are excluded from this computation since they are textually identical. In some implementations, pairs between different identified 230 representative queries are excluded for this computation. As such, in these implementations, each pair of queries for which a textual similarity score is computed is between (a) an obtained 220 simplified query that is not one of the identified 230 representative queries and (b) an identified 230 representative query.

A variety of different textual similarity measures may be used to compute the textual similarity score. For example, a character-based textual similarity measure or a term-based textual similarity measure may be used.

Non-limiting examples of character-based textual similarity measures that may be used include longest common substring (LCS) (Considers the similarity between two strings is based on the length of contiguous chain of characters that exist in both strings.), Damerau-Levenshein (Defines distance between two strings by counting the minimum number of operations needed to transform one string into the other, where an operation is defined as an insertion, deletion, or substitution of a single character, or a transposition of two adjacent characters.), Jaro (Based on the number and order of the common characters between two strings; it takes into account typical spelling deviations and mainly used in the area of record linkage.), Jaro-Winkler (An extension of Jaro distance; it uses a prefix scale which gives more favorable ratings to strings that match from the beginning for a set prefix length.), Needleman-Wunch (Performs a global alignment to find the best alignment over the entire of two sequences. It is suitable when the two sequences are of similar length, with a significant degree of similarity throughout.), Smith-Waterman (Performs a local alignment to find the best alignment over the conserved domain of two sequences. It is useful for dissimilar sequences that are suspected to contain regions of similarity or similar sequence motifs within their larger sequence context.), and N-gram (A sub-sequence of n items from a given sequence of text. N-gram similarity algorithms compare the n-grams from each character or word in two strings. Distance is computed by dividing the number of similar n-grams by maximal number of n-grams.).

Non-limiting examples of term-based textual similarity measures that may be used include block distance (Also known as Manhattan distance, boxcar distance, absolute value distance, L1 distance, city block distance and Manhattan distance. It computes the distance that would be traveled to get from one data point to the other if a grid-like path is followed. The Block distance between two items is the sum of the differences of their corresponding components.), cosine similarity (A measure of similarity between two vectors of an inner product space that measures the cosine of the angle between them.), Dice's coefficient (Defined as twice the number of common terms in the compared strings divided by the total number of terms in both strings.), Euclidean distance (Or L2 distance is the square root of the sum of squared differences between corresponding elements of the two vectors.), Jaccard similarity (Computed as the number of shared terms over the number of all unique terms in both strings.), matching coefficient (A vector based approach which counts the number of similar terms, (dimensions), on which both vectors are non-zero/), and overlap coefficient (Similar to the Dice's coefficient, but considers two strings a full match if one is a subset of the other.)

It is also possible to use a corpus-based textual similarity measure to compute the textual similarity score that determines the similarity between two strings according to information gained from the vertical search corpus.

A combination of textual similarity measures may also be used for given query pair. For example, multiple textual similarity scores according to different textual similarity measures may be computed and then combined into a single textual similarity score. The combination may be based on applying numerical weights associated with the different textual similarity measures to the textual similarity scores produced by the different textual similarity measures.

However a textual similarity score is computed for an obtained 220 simplified query and an identified 230 representative query, the score may be compared to a threshold score at operation 250. If the score is above the threshold (or below the threshold if a lower score indicates higher similarity), then an entry is added to the query mapping dictionary 260. The entry maps the simplified query to the representative query. For example, a misspelled query such as “termanate account” may be the simplified query and the correctly spelled query “terminate account” may be the representative query to which the simplified query is mapped by the entry.

The threshold to which the textual similarity score is compared at operation 250 may vary depending on the textual similarity measure or measures used to compute the textual similarity score. In general, the threshold should be selected such that an obtained 220 simplified query is mapped an identified 230 representative query in the query mapping dictionary if the representative query returns more a more relevant search result when executed against the vertical search corpus than the simplified query does. Here, relevance can be measured by the click-through rates of the respective search results. As such, the threshold may be determined and tuned empirically based on the observed click-through rates for the queries.

As a result of performing process 200, the search system is able to determine entries to add to the query mapping dictionary for mapping map long tail or less popular (e.g., misspelled) user queries such as, for example, “termanate my account” “that do not return relevant documents when submitted against a vertical search corpus of documents (e.g., a technical knowledge base of authored articles) to more representative queries such as, for example, “terminate account” that do return relevant documents.

### Semantic Similarity Approach

FIG. 3 is a process 300 for determining entries to include in the query mapping dictionary according to the semantic similarity between historical user queries. The process 300 includes the operations of obtaining a sequence of historical user queries 310 and identifying 320 successful queries in the sequence of historical user queries. For successful queries identified in the sequence, query pairs may be formed 330 where each query pair is composed of a prior unsuccessful query in a user's search session and the identified successful query. Such query pairs are aggregated across multiple user search sessions 340. On the condition 350 that there are more than a threshold number of query pairs in the aggregate all with the same unsuccessful query and the same successful query pair, then an entry is added to the query mapping dictionary where the entry maps a simplified form of the unsuccessful query to a simplified form of the successful query 360.

It should be noted that the condition of operation 350 that more than a threshold number of the same query pair exist in the aggregate may not be sufficient to perform operation 360 in some implementations or in some instances. For example, one or more other conditions in addition to the condition of operation 350 may each may be required to be satisfied as a condition on performing operation 360. However, in other implementations or in other circumstances, satisfaction of the condition of operation 350 may be sufficient for performing operation 360. Furthermore, process 300 is not exclusive of another process in which an entry is added to the query mapping dictionary based on semantic similarities between queries even though the condition of operation 350 may not be satisfied.

Returning again to the top of process 300, a sequence of historical user queries submitted to the search system during a user's search session is obtained 310. The sequence of historical user queries may be obtained from a log or logs maintained by the search system such as, for example, the previously described query log. The historical search queries may be ordered in the sequence by time (e.g., the date and time of the query was obtained, processed, and/or answered by the search system as record in the query log). The historical search queries in the sequence may be submitted by different users and may span a period of time (e.g., the past month, the past 90 days, etc.).

The sequence of historical user queries obtained 310 may be partitioned into search sessions. A search session may be defined as a sequence of historical user queries submitted by a user to the search system within a short time interval (e.g. within a few minutes). A search session may contain the sequence of query reformulations issued by the user while attempting to complete the search mission. Therefore, query co-occurrence in the same session is a strong signal of query relatedness.

For example, a search session might include the following sequence of search queries submitted by a user:

1. “eliminate account”

2. “void account”

3. “terminate account”

4. “close account”

With this query sequence, the user might not receive a search result that satisfies the user's information need until after the last query “close account” is submitted depending on the keywords contained in or associated with the document of interest. In this case, the user may consider the prior three queries as unsuccessful and consider the last query successful. This type of search session querying pattern can be exploited to identify unsuccessful queries that are semantically related to co-occurring successful queries in a search session.

At operation 320, successful queries are identified from among the sequence of historical user queries obtained 310. The success of a given historical user query may be measured and identified 320 according one or more search result relevance metrics and/or an effectiveness score such as those discussed above with respect to operation 230 of process 200. A historical user query that is not successful according to the search result relevance metrics and/or an effectiveness score may be considered unsuccessful. Given a successful query submitted by a particular user identified 320 in the sequence of historical user queries obtained 310, then a search session may be identified as the sub-sequence of a number N of prior unsuccessful queries submitted by the particular user that immediately precede the successfully query in the sequence. As such, an unsuccessful query that may be paired 330 with a successful query submitted by a particular user may be one submitted by the particular user where there are no intervening successful queries submitted by the particular user in the sequence of historical user queries obtained 310 between the unsuccessful query and the successful query. A historical user query obtained 310 may be associated with a particular user by the user identifier or session identifier associated with the historical user query in the query log.

In some implementations, N is five, for example, but may be higher or lower according to the requirements of the particular implementation at hand. In some implementations, an unsuccessful query submitted by a particular user that immediately precedes a successful query submitted by the particular user in the sequence of historical user queries obtained 310 is not included in a search session unless the unsuccessful query was submitted to the search system within a threshold amount of time (e.g., a few minutes) of the successful query being submitted. This time constraint may prevent queries that are not directed to the same user information need from being included in the same search session.

At operation 330, query pairs are formed where each query pair is composed of an unsuccessful query submitted by a particular user during a search session and the subsequent successful query submitted by the particular user during the search session. Return to the example above, the following query pairs may be formed for the example search session where the query “close account” is the successful query in each query pair and the other query in the pair is the unsuccessful query:
(“eliminate account”, “close account”)
(“void account”, “close account”)
(“terminate account”, “close account”)

At operation 340, query pairs formed 330 are aggregated across multiple search sessions. As such, operation 330 may be performed multiple times for multiple search sessions where each such search session corresponds to a successful query identified 320 in the sequence of historical user queries obtained 310. Returning to operation 340, all identical query pairs are counted. Two query pairs are identical for this purpose if the associate the same unsuccessful query with the same successful query. For example, all of the query pairs (“eliminate account”, “close account”) aggregated across multiple search sessions are counted and all of the query (“void account”, “close account”) aggregated across multiple search are counted resulting in two counts: (1) the count of the number of query pairs that are (“eliminate account”, “close account”) and (2) the count of the number of query pairs that are (“void account”, “close account”).

At operation 360, an entry is added to the query mapping dictionary for a query pair formed 330 on the condition 350 that that the count of the number of query pair instances for the query pair in the aggregate exceeds a threshold. The threshold may be selected according to the requirements of the particular implementation at hand. In general, however, the threshold is preferably greater than one to avoid adding an entry mapping an unsuccessful query that is relatively unlikely to be submitted again to the search system. The entry added 360 for the query pair may map a simplified form of the unsuccessful query of the query pair to a simplified form of the successful query of the query pair. The simplified forms may be obtained by using the same transformation operation applied to transform a user query to a simplified query as described above with respect to process 100.

### System Overview

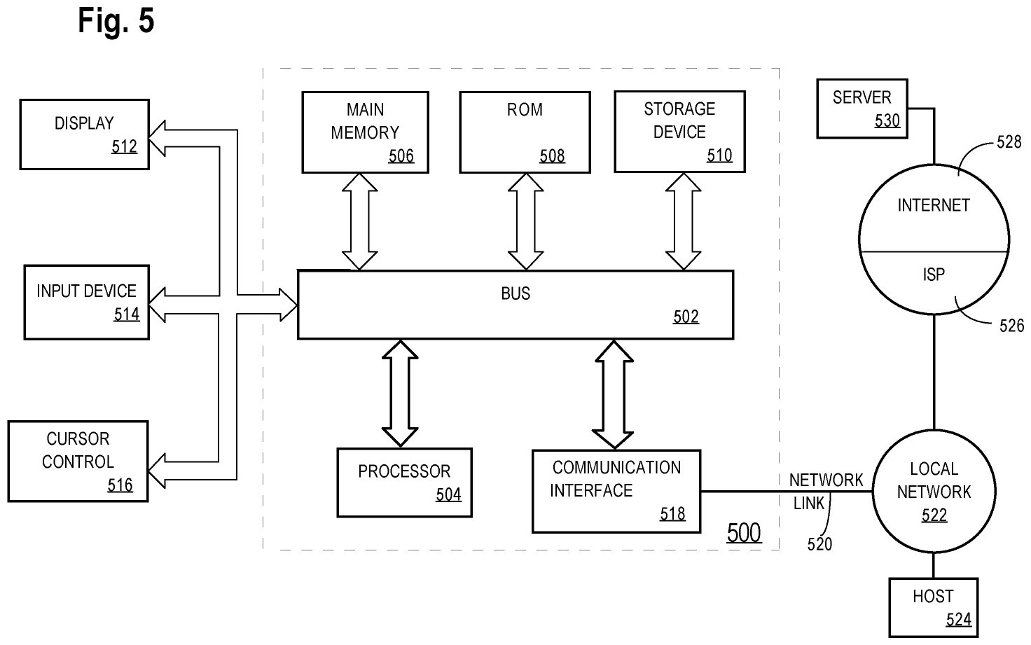

FIG. 4 is a schematic diagram of an example search system 400 in which the techniques disclosed herein, including processes 100, 200, and 300 above, may be implemented. The system 400 includes a user computer 410 coupled to a search front end 430 by a data network 420. The search frontend 430 is coupled to a query mapper 440 which is coupled to a query mapping dictionary 450 and set of one or more searcher shards 460. The query mapping dictionary 450 is generated by a dictionary builder 460 which has access to logs 470 which may store one or more the logs discussed above (e.g., a query log, a search result log, and a click-through log). The query mapper 440 and the dictionary builder 460 may be implemented by a computing system comprising one or more processors and storage media. The computing system may be composed of one or more computing devices such as computer system 500 described below with respect to FIG. 5. The query mapper 440 may be configured to perform process 100 described above. The dictionary builder 460 may be configured to perform process 200 and/or process 300 described above.

The search system 400 may support building a search index, searching the index for matching documents, and determining the importance of matching documents through relevance scores. Building the search index may be accomplished by calling (invoking) an application program interface (API) that adds entries to the index. The search index may have two primary components: an inverted index and a forward index. The inverted index maps keywords to a list of documents that contain or are associated with the keywords. The forward index maps documents to metadata about the documents. A list of documents associated with a keyword in the inverted index is sometimes referred to as a “postings list.” A search of the index may take place by building a query contained keywords and then walking the postings lists of these keywords to find documents that satisfy the query constraints. Relevance scores may be determined from detail of posit list matches and from information in the forward index.

It may be the case that the indices of the search system 400 are sufficiently large such that they cannot be served from a single server computer. In this case, the index may be broken up into pieces called shards where each shard indexed a subset of the documents in the document corpus. Each shard may be served from a separate server computer.

During operation of the search system 400, a user query may be obtained by the search frontend 430 from a user computer 410 over the data network 420 (e.g., the internet). The query mapper 440 may map the user query to a more representative query by consulting query mapping dictionary 450. The query mapping dictionary 450 may be constructed by dictionary builder 460 based on information about historical user queries in the logs 470. The query mapper 440 may submit the representative query to one or more searcher shards 460. The results returned from the search shards 460 may be combined into a search result that is returned to user computer 410 via the search front end 430 over the data network 420.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### EXTENSIONS AND ALTERNATIVES

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method, comprising:
obtaining a user query string;
transforming the user query string to a particular simplified query string;
using the particular simplified query string as a key for accessing a query mapping dictionary to obtain a particular representative query string to which the particular simplified query string is mapped by an entry of the query mapping dictionary;
using the particular representative query string to search a vertical search corpus; and
wherein the computer-implemented method is performed by a computing system comprising one or more processors and storage media storing one or more programs having instructions configured to perform the computer-implemented method.

2. The computer-implemented method of claim 1, wherein the transforming the user query string to the particular simplified query string is based on applying a lemmatization process to an input query string; wherein the input query string is based on the user query string; and wherein the particular simplified query string is based on a query string output by the lemmatization process applied to the input query string.

3. The computer-implemented method of claim 2, wherein the input query string matches the user query string.

4. The computer-implemented method of claim 2, wherein the input query string is obtained by applying one or more transformation processes to one or more input query strings wherein at least one of the one or more transformation processes is applied to the user query string.

5. The computer-implemented method of claim 2, wherein the query string output by the lemmatization process matches the particular simplified query string.

6. The computer-implemented method of claim 2, wherein the particular simplified query string is obtained by applying one or more transformation processes to one or more input query strings wherein at least one of the one or more transformation processes is applied to the query string output by the lemmatization process.

7. The computer-implemented method of claim 1, wherein the transforming the user query string to the particular simplified query string is based on applying a parts-of-speech tagging and pattern matching process to an input query string; wherein the input query string is based on the user query string; and wherein the particular simplified query string is based on a query string output by the parts-of-speech tagging and pattern matching process applied to the input query string.

8. The computer-implemented method of claim 7, wherein the input query string matches the user query string.

9. The computer-implemented method of claim 7, wherein the input query string is obtained by applying one or more transformation processes to one or more input query strings wherein at least one of the one or more transformation processes is applied to the user query string.

10. The computer-implemented method of claim 7, wherein the query string output by the parts-of-speech tagging and pattern matching process matches the particular simplified query string.

11. The computer-implemented method of claim 7, wherein the particular simplified query string is obtained by applying one or more transformation processes to one or more input query strings wherein at least one of the one or more transformation processes is applied to the query string output by the parts-of-speech tagging and pattern matching process.

12. The computer-implemented method of claim 1, further comprising:
prior to obtaining the user query string:
obtaining a set of historical user query strings and a set of simplified query strings, each simplified query string in the set of simplified queries strings based on one corresponding historical user query string of the set of historical user query strings, the set of simplified query strings including the particular simplified query string;
identifying a set of representative query strings from among the set of simplified query strings, the set of representative query strings including the particular representative query string;
measuring textual similarity between simplified query strings in the set of simplified query strings and representative query strings in the set of representative query strings; and
adding the entry to the query mapping dictionary based on a textual similarity measure between the particular simplified query string and the particular representative query string being above a threshold textual similarity.

13. The computer-implemented method of claim 1,
prior to obtaining the user query string:
obtaining a sequence of historical user query strings;
identifying successful query strings in the sequence of historical user query strings;
forming a particular query pair composed of an unsuccessful query string in a search session and a successful query string in the search session, the unsuccessful query string preceding the successful query string in the sequence of historical user query strings; and
adding the entry to the query mapping dictionary based on a number of instances of the particular query pair identified in the sequence of historical user query strings being above a threshold.

14. One or more non-transitory computer-readable media storing one or more programs for execution by a computing system comprising one or more processors, the one or more programs having instructions configured for:
obtaining a set of historical user queries and a set of simplified queries, each simplified query in the set of simplified queries based on one corresponding historical user query of the set of historical user queries;
identifying a set of representative queries from among the set of simplified queries;
measuring textual similarity between simplified queries in the set of simplified queries and representative queries in the set of representative queries; and
adding an entry to a query mapping dictionary based on a textual similarity measure between a particular simplified query in the set of simplified queries and a particular representative query in the set of representative queries being above a threshold textual similarity.

15. The one or more non-transitory computer-readable media of claim 14, the instructions further configured for:
obtaining a user query;
transforming the user query to the particular simplified query;
using the particular simplified query as a key for accessing a query mapping dictionary to obtain the particular representative query to which the particular simplified query string is mapped by the entry of the query mapping dictionary; and
using the particular representative query to search a vertical search corpus.

16. The one or more non-transitory computer-readable media of claim 14, wherein the identifying the set of representative queries from among the set of simplified queries is based on one or more search result relevance metrics associated with historical queries in the set of historical user queries.

17. A computing system comprising:
one or more processors;
storage media;
one or more programs stored in the storage media, the one or more programs comprising instructions configured for:
obtaining a sequence of historical user queries;
identifying successful queries in the sequence of historical user queries;
forming a particular query pair composed of an unsuccessful query in a search session and a successful search query in the search session, the unsuccessful query preceding the successful search query in the sequence of historical user queries; and
adding an entry to a query mapping dictionary based on a number of instances of the particular query pair identified in the sequence of historical user queries being above a threshold.

18. The computing system of claim 17, the instructions further configured for:
obtaining a user query;
transforming the user query to a particular simplified query;
using the particular simplified query as a key for accessing a query mapping dictionary to obtain a particular representative query to which the particular simplified query string is mapped by the entry of the query mapping dictionary; and
using the particular representative query to search a vertical search corpus.

19. The computing system of claim 17, wherein the identifying the successful queries in the sequence of historical user queries is based on one or more search result relevance metrics associated with historical user queries in the sequence of historical user queries.

20. The computing system of claim 19, wherein the one or more search result relevance metrics include at least one of the following search result relevance metrics for each historical user query in the sequence of historical user queries:
a click-through rate for the historical user query, or
a hit rate for the historical user query.
